(19) United States
(12) Patent Application Publication
(10) Pub. No.: US 2025/0285141 A1
(43) Pub. Date: Sep. 11, 2025

(54) INFORMATION PROCESSING DEVICE, CONTENT SWITCHING METHOD, VEHICLE, AND PROGRAM

(71) Applicant: TOYOTA BOSHOKU KABUSHIKI KAISHA, Aichi (JP)

(72) Inventors: Osamu KAWASE, Aichi (JP); Hiroki ASHIZAWA, Aichi (JP); Nobuki HAYASHI, Aichi (JP); Yuki KAMIYA, Aichi (JP); Tetsuro SAKAGUCHI, Aichi (JP); Tomonori ISHIKAWA, Aichi (JP)

(73) Assignee: TOYOTA BOSHOKU KABUSHIKI KAISHA, Aichi (JP)

(21) Appl. No.: 19/013,450

(22) Filed: Jan. 8, 2025

(30) Foreign Application Priority Data
Mar. 8, 2024 (JP) 2024-036169

(51) Int. Cl. G06Q 30/0251

(52) U.S. Cl. CPC G06Q 30/0266

(57) ABSTRACT

An information processing device suspends provision of non-advertisement content and starts provision of advertisement content, in a case where (a) a first determining section determines that a traveling body has stopped traveling while the non-advertisement content is being provided and (b) a second determining section determines to permit suspension of provision of the non-advertisement content.

This Nonprovisional application claims priority under 35 U.S.C. § 119 on Patent Application No. 2024-036169 filed in Japan on Mar. 8, 2024, the entire contents of which are hereby incorporated by reference.

### TECHNICAL FIELD

The present disclosure relates to an information processing device, a content switching method, a vehicle, and a program.

### BACKGROUND ART

Patent Literature 1 discloses a content providing method according to which, when it is determined that a vehicle stops, an estimated stopping period is calculated and advertisement content which can be played back within the estimated stopping period is output.

### CITATION LIST

### Patent Literature

### [Patent Literature 1]

Japanese Patent Application Publication, Tokukai, No. 2021-039503

### SUMMARY OF INVENTION

### Technical Problem

According to the content providing method disclosed in Patent Literature 1, it is necessary to calculate the estimated stopping time period of the vehicle. An aspect of the present has an object to provide advertisement content while a traveling body stops, even without estimating a time period during which the traveling body stops.

### Solution to Problem

In order to attain the above object, an information processing device in accordance with an aspect of the present disclosure is an information processing device that provides content including advertisement content and non-advertisement content to a passenger of a traveling body, the information processing device including: a first determining section configured to determine whether the traveling body is traveling or the traveling body has stopped traveling; and a second determining section configured to determine, on a basis of whether a first time period elapsed from a timing of starting provision of the non-advertisement content is a given first suspension time period, whether to permit suspension of provision of the non-advertisement content, provision of the non-advertisement content being suspended and provision of the advertisement content being started, in a case where (a) the first determining section determines that the traveling body has stopped traveling while the non-advertisement content is being provided and (b) the second determining section determines to permit suspension of provision of the non-advertisement content.

In order to attain the above object, a content switching method in accordance with another aspect of the present disclosure is a content switching method that switches content which is to be provided to a passenger of a traveling body between advertisement content and non-advertisement content, the content switching method including: suspending provision of the non-advertisement content and starting provision of the advertisement content, in a case where (a) the traveling body stops while the non-advertisement content is being provided and (b) a time period elapsed from a timing of starting provision of the non-advertisement content is a given time period.

An information processing device in accordance with each aspect of the present disclosure may be realized by a computer. In this case, the present disclosure encompasses: a program for the information processing device, the program causing a computer to operate as the sections (software elements) included in the information processing device SO that the information processing device is realized by the computer; and a computer-readable storage medium in which the program is stored.

### Advantageous Effects of Invention

In accordance with an aspect of the present disclosure, it is possible to provide advertisement content while a traveling body stops, even without estimating a time in which the traveling body stops.

### BRIEF DESCRIPTION OF DRAWINGS

FIG. 1 is a block diagram illustrating an example of a configuration of a content providing system that uses an information processing device in accordance with an embodiment of the present disclosure.

FIG. 2 is a view illustrating an example of a configuration of an information processing device in accordance with an embodiment of the present disclosure.

FIG. 3 is a view used to explain a second determining section and a third determining section.

FIG. 4 is a view used to explain a content switching method in accordance with an embodiment of the present disclosure.

### DESCRIPTION OF EMBODIMENTS

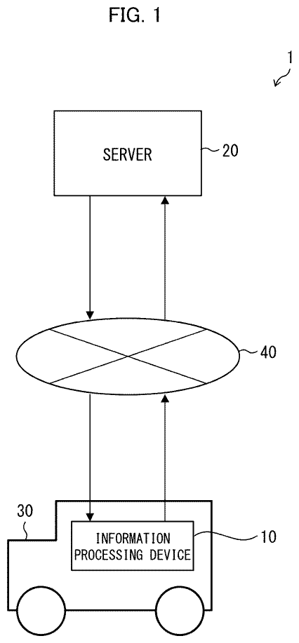

FIG. 1 is a block diagram illustrating an example of a configuration of a content providing system that uses an information processing device in accordance with an embodiment of the present disclosure. A content providing system 1 shown in FIG. 1 includes an information processing device 10 and a server 20. For example, the information processing device 10 is disposed inside a vehicle 30, and provides content to a passenger of the vehicle 30. The vehicle 30 is one example of the traveling body, and is, for example, an automobile, a bus, or a taxi. The content is the one that can be sensed by the passenger with five senses. The content includes a video, an audio, a vibration, an odor, and/or mist, for example.

The server 20 is disposed outside the information processing device 10. The server 20 has a function to transmit, to the information processing device 10, data of the content that the information processing device 10 provides to the passenger. The data of the content includes: guiding content for providing information about (i) a facility existing in an area surrounding a road on which the vehicle 30 travels, (ii) a building that is visually recognizable through a window of the vehicle 30, and/or (iii) a landmark(s) such as a river and/or a mountain; and advertising content for advertisement. The guiding content is one example of the non-advertisement content.

The data relating to the guiding content includes (i) information indicative of a position (a latitude, a longitude, and/or an altitude) of a subject to be guided (i.e., a guiding subject) such as a facility and/or a landmark, (ii) data indicative of a video and/or an audio relating to the guiding subject, and (iii) information about a playback time period of a video and/or an audio.

The information processing device 10 and the server 20 are connected to a network 40 such as a wireless communication network, an Internet network, or a telephone line network. For convenience of explanation, FIG. 1 illustrates a single information processing device 10. Alternatively, the content providing system 1 may include a plurality of information processing devices 10. Further, the information processing device 10 and the server 20 may be connected to, via the network 40 and/or the like, an information terminal, a server, and/or the like (not illustrated). For example, the information processing device 10 and the server 20 may be connected to an information terminal possessed by the passenger of the vehicle 30. The information processing device 10 obtains data of non-advertisement content such as the guiding content and advertisement content from the server 20 via the network 40.

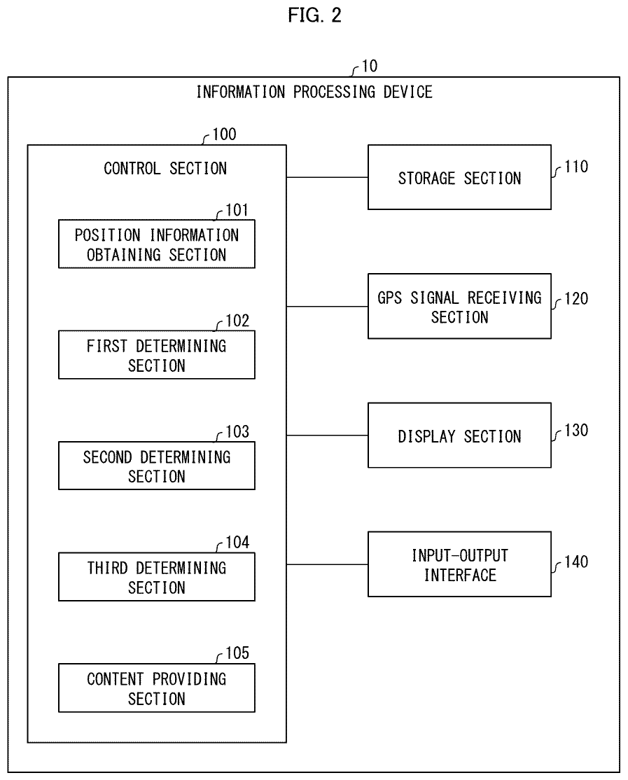

FIG. 2 is a view illustrating an example of a configuration of the information processing device in accordance with the embodiment of the present disclosure. As shown in FIG. 2, the information processing device 10 includes a control section 100, a storage section 110, a GPS signal receiving section 120, a display section 130, and an input-output interface 140.

The control section 100 includes, e.g., a central processing unit (CPU) and a main storage device. The storage section 110 includes, e.g., a hard disk drive (HDD) and/or a solid state drive (SSD). In the storage section 110, a program to be executed by the control section 100 and data of content transmitted from the server 20 are stored.

The GPS signal receiving section 120 receives a signal from a GPS satellite. The display section 130 is one example of the output device, and can be used to provide content such as a still image and/or a moving image. The input-output interface 140 is, for example, a universal serial bus (USB) terminal and/or a local area network (LAN) terminal. The information processing device 10 is connected, via the input-output interface 140, to a vehicle communication network such as a controller area network (CAN). The information processing device 10 is connectable to the network 40 via CAN.

By executing the program stored in the storage section 110, the control section 100 functions as a position information obtaining section 101, a first determining section 102, a second determining section 103, a third determining section 104, and a content providing section 105.

The position information obtaining section 101 obtains position information indicative of a current position of the vehicle 30. For example, the position information obtaining section 101 obtains, on the basis of a signal that the GPS signal receiving section 120 has received from a GPS satellite, position information indicative of a current position of the vehicle 30. The position information obtaining may be connected to CAN via the input-output interface 140 and may be configured to obtain vehicle information about a vehicle speed of the vehicle 30, an acceleration of the vehicle 30, and amounts of operation of an accelerator pedal, a brake pedal, and a steering wheel of the vehicle 30 and to use the vehicle information to calculate the current position of the vehicle 30.

The first determining section 102 determines whether the vehicle 30 is traveling or the vehicle 30 has stopped traveling. Examples of the state in which “the vehicle 30 has stopped traveling” include a state in which the vehicle 30 stops and a state in which the vehicle 30 is parked. For example, in a case where the position information obtained by the position information obtaining section 101 does not change, the first determining section 102 determines that the vehicle 30 has stopped traveling. Meanwhile, in a case where the position information obtained by the position information obtaining section 101 changes, the first determining section 102 determines that the vehicle 30 is traveling.

The content providing section 105 provides content through, e.g., the display section 130 of the information processing device 10, an output device provided to the vehicle 30, or an output device possessed by the passenger.

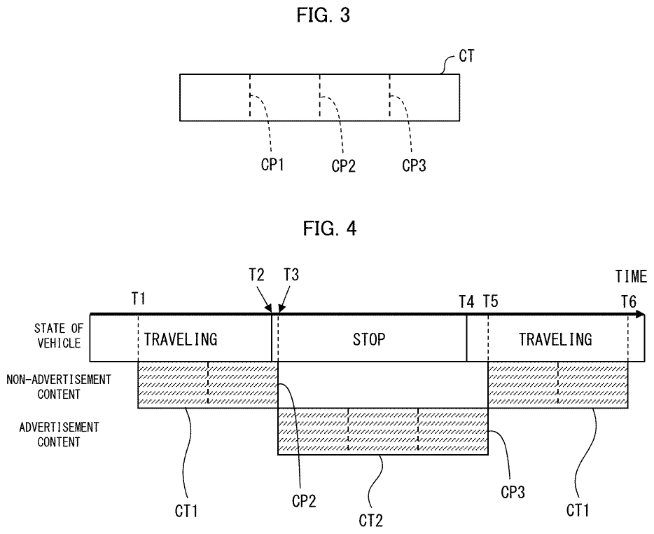

FIG. 3 is a view used to explain the second determining section 103 and the third determining section 104. The data of the content transmitted from the server 20 to the information processing device 10 includes at least one suspension time period during which suspension of provision of content is permitted. Content CT shown in FIG. 3 includes three suspension time periods CP1, CP2, and CP3.

In a case where the content CT is non-advertisement content such as guiding content, each of the suspension time period periods CP1, CP2, and CP3 is one example of the first suspension time period. The second determining section 103 shown in FIG. 2 determines, on the basis of whether or not a time period elapsed from a timing of starting provision of non-advertisement content is any of the suspension time periods CP1, CP2, and CP3, whether to permit suspension of provision of the non-advertisement content. In a case where the period of time elapsed from the timing of starting provision of the non-advertisement content is any of the suspension time periods CP1, CP2, and CP3 for the non-advertisement content, the second determining section 103 determines to permit suspension of provision of the non-advertisement content. Meanwhile, in a case where the period of time elapsed from the timing of starting provision of the non-advertisement content is not the suspension time period CP1, CP2, or CP3 for the non-advertisement content, the second determining section 103 determines not to permit suspension of provision of the non-advertisement content.

In a case where the content CT is advertisement content, the suspension time periods CP1, CP2, and CP3 are examples of a second suspension time period. The third determining section 104 shown in FIG. 2 determines, on the basis of whether or not a time period elapsed from a timing of starting provision of the advertisement content is any of the suspension time periods CP1, CP2, and CP3, whether to permit suspension of provision of the advertisement content. In a case where the time period elapsed from the timing of starting provision of the advertisement content is any of the suspension time periods CP1, CP2, and CP3 for the advertisement content, the third determining section 104 determines to permit suspension of provision of the advertisement content. Meanwhile, in a case where the time period elapsed from the timing of starting provision of the advertisement content is not the suspension time period CP1, CP2, or CP3 for the advertisement content, the third determining section 104 determines not to permit suspension of provision of the advertisement content.

Each of the suspension time periods CP1, CP2, and CP3 is provided at a timing which provides a good separation in the content CT. Providing the “good separation in the content CT” means that suspending provision of the content CT with a low possibility of giving the passenger an uncomfortable feeling and/or a strange feeling. For example, in a case where the content CT is video content, the video content may be suspended at a timing when a video scene is switched from one to another. This can decrease the possibility of giving the passenger an uncomfortable feeling and/or a strange feeling. In a case where the content CT is audio content, the audio content may be suspended on the basis of, e.g., a breath group in the audio which is being output and/or a section in music. This can decrease the possibility of giving the passenger an uncomfortable feeling and/or a strange feeling.

In a case where the content CT is prepared so that a good separation is given at each given time period (e.g., 15 seconds), the suspension time periods CP1, CP2, and CP3 may be set in advance in the process of preparing the content CT.

Alternatively, the suspension time periods CP1, CP2, and CP3 may be set on the basis of a similarity between pieces of content which are to be output consecutively during or before provision of the content CT. For example, in a case where the content CT is video content, feature vectors of frame images in respective frames may be calculated, and frames in each of which a cosine similarity between two consecutive frames is not more than a given threshold may be regarded as the suspension time period CP1, CP2, or CP3.

FIG. 4 is a view used to explain a content switching method in accordance with an embodiment of the present disclosure. FIG. 4 illustrates an example of changes over time in (i) a state of the vehicle 30, (ii) a state of provision of the non-advertisement content CT1, and (iii) a state of provision of the advertisement content CT2.

In FIG. 4, the vehicle 30 stops at a timing T2, and starts traveling at a timing T4. Thus, the first determining section 102 determines that the vehicle 30 stops and is not traveling during a period from the timing T2 to the timing T4, and determines that the vehicle 30 is traveling before the timing T2 and after the timing T4.

The information processing device 10 starts providing the non-advertisement content CT1 to the passenger of the vehicle 30 at a timing T1, which is before the timing T2. When the vehicle stops at the timing T2, a first time period elapsed from the timing T1 of starting provision of the non-advertisement content CT1 is not the suspension time period CP1, CP2, or CP3 for the non-advertisement content CT1. Thus, at the timing T2, the second determining section 103 determines not to permit suspension of provision of the non-advertisement content CT1. At a timing T3 between the timings T2 and T4, the first time period reaches the suspension time period CP2 for the non-advertisement content CT1; therefore, the second determining section 103 determines to permit suspension of provision of the non-advertisement content CT1. At the timing T3, the information processing device 10 suspends provision of the non-advertisement content CT1, and starts provision of the advertisement content CT2.

By suspending provision of the non-advertisement content CT1 after the suspension time period for the non-advertisement content CT1 comes rather than by suspending provision of the non-advertisement content CT1 immediately at the time when the vehicle 30 stops, it is possible to prevent an uncomfortable feeling and/or a strange feeling from being given to the passenger of the vehicle 30. By providing the advertisement content CT2 mainly while the vehicle 30 stops, it is possible to avoid a situation in which the passenger cannot enjoy a scenery through the window of the vehicle. Further, by providing the advertisement content CT2 while the vehicle 30 stops, it is possible to increase the change that the advertisement content CT2 catches the passenger's attention.

When the vehicle starts traveling at the timing T4, a second time period elapsed from the timing T3 of starting provision of the advertisement content CT2 is not the suspension time period CP1, CP2, or CP3 for the advertisement content CT2. Thus, the third determining section 104 determines not to permit suspension of provision of the advertisement content CT2 at the timing T4. At a timing T5, which is later than the timing T4, the second time period reaches the suspension time period CP3 for the advertisement content CT2; therefore, the third determining section 104 determines to permit suspension of provision of the advertisement content CT2. At the timing T5, the information processing device 10 suspends provision of the advertisement content CT2 and restarts provision of the non-advertisement content CT1. As shown in FIG. 4, the information processing device 10 may start provision of the non-advertisement content CT1 at the timing T3 when provision of the non-advertisement content CT1 is suspended. In FIG. 4, provision of the non-advertisement content CT1 is completed at a timing T6, which is later than the timing T5.

### Effects

As explained above, according to the information processing device 10 in accordance with the present embodiment, it is possible to attain the following effects.

The information processing device 10 provides the content including the advertisement content CT2 and the non-advertisement content CT1 to the passenger of the vehicle 30, and includes the first determining section 102 and the second determining section 103. The first determining section 102 determines whether the vehicle 30 is traveling or the vehicle 30 has stopped traveling. The second determining section 103 determines, on the basis of whether the first time period elapsed from the timing T1 of starting provision of the non-advertisement content CT1 is any of the suspension time periods CP1, CP2, and CP3 for the non-advertisement content CT1, whether to permit suspension of provision of the non-advertisement content CT1. In a case where (a) the first determining section 102 determines that the vehicle 30 has stopped traveling while the non-advertisement content CT1 is being provided and (b) the second determining section 103 determines to permit suspension of provision of the non-advertisement content CT1 (T3), provision of the non-advertisement content CT1 is suspended and provision of the advertisement content CT2 is started. In accordance with the above embodiment, it is possible to provide the advertisement content CT2 when the vehicle 30 stops, even without estimating a time period during which the vehicle 30 stops.

The information processing device 10 further includes the third determining section 104. The third determining section 104 determines, on the basis of whether or not a second time period from the timing T3 of starting provision of the advertisement content CT2 is any of the suspension time periods CP1, CP2, and CP3 for the advertisement content CT2, whether to permit suspension of provision of the advertisement content CT2. In a case where (a) the first determining section 102 determines that the vehicle 30 is traveling while provision of the non-advertisement content CT1 is suspended and the advertisement content CT2 is being provided and (b) the third determining section 104 determines to permit suspension of provision of the advertisement content CT2, provision of the advertisement content CT2 is suspended. In accordance with the above embodiment, it is possible to suspend provision of the advertisement content CT2 when the vehicle 30 travels, even without giving a strange feeling to the passenger.

The information processing device 10 is configured as follows. In a case where (a) the first determining section 102 determines that the vehicle 30 is traveling while provision of the non-advertisement content CT1 is suspended and the advertisement content CT2 is being provided and (b) the third determining section 104 determines to permit suspension of provision of the advertisement content CT2, provision of the non-advertisement content CT1 whose provision has been suspended is restarted. In accordance with the above embodiment, provision of the non-advertisement content CT1 whose provision has been suspended is restated. This makes it easy to complete provision the non-advertisement content CT1.

The content switching method explained with reference to FIG. 4 is a method for switching content which is to be provided to the passenger of the vehicle 30 between the advertisement content CT2 and the non-advertisement content CT1. In a case where (a) the vehicle 30 stops while the non-advertisement content CT1 is being provided and (b) a time period elapsed from a timing of starting provision of the non-advertisement content CT1 is any of the given suspension time periods CP1, CP2, and CP3, provision of the advertisement content CT1 is suspended and provision of the advertisement content CT2 is started. According to the above embodiment, it is possible to provide the advertisement content CT2 when the vehicle 30 stops, even without estimating a time period during which the vehicle 30 stops.

The vehicle 30 includes the information processing device 10.

### Software Implementation Example

The functions of the information processing device 10 (hereinafter, referred to as a “device”) can be realized by a program for causing a computer to function as the device, the program causing the computer to function as the control blocks (particularly, the sections included in the control section 100) of the device.

In this case, the device includes, as hardware for executing the program, at least one control device (e.g., a processor) and at least one storage device (e.g., a memory). By causing the control device and the storage device to execute the program, the functions explained in the foregoing embodiments are realized.

The program may be recorded in one or more non-transitory computer-readable recording media. The recording media may or may not be included in the device. In the latter case, the program may be supplied to or made available to the device via any wired or wireless transmission medium.

Furthermore, some or all of the functions of the control blocks can also be realized by a logic circuit. For example, the present disclosure encompasses, in its scope, an integrated circuit in which a logic circuit that functions as each of the above-described control blocks is formed. In addition, the function of each of the control blocks can be realized by, for example, a quantum computer.

The processes described in the foregoing embodiments may be carried out by artificial intelligence (AI). In this case, AI may be operated in the control device, or may be operated in another device (e.g., an edge computer or a cloud server).

### Variations

The foregoing embodiment has dealt with the case where the information processing device 10 is provided inside the vehicle 30. However, even in a case where an information processing device in accordance with an embodiment of the present disclosure is disposed inside a traveling body other than the vehicle 30, for example, a railroad train, an aircraft, or a ship, it is possible to provide similar effects.

In the foregoing embodiment, the information processing device 10 is configured such that data of content which is to be provided to the passenger is transmitted from the server 20 to the information processing device 10. Alternatively, however, the data of the content may be stored in the storage section 110 of the information processing device 10 in advance.

In the foregoing embodiment, the control section 100 of the information processing device 10 disposed inside the vehicle 30 functions as the first determining section 102, the second determining section 103, and the third determining section 104. However, the information processing device including the first determining section 102, the second determining section 103, and the third determining section 104 may be disposed outside the vehicle 30. For example, the server 20 may function as the information processing device. In a case where the server 20 is caused to function as the first determining section 102, the second determining section 103, and the third determining section 104, (i) position information of the vehicle 30 and/or (ii) vehicle information about a vehicle speed, an acceleration, and/or an amount of operation of an accelerator pedal of the vehicle 30 may be transmitted from the information processing device 10 to the server 20.

### SUPPLEMENTARY REMARKS

The present disclosure is not limited to the embodiments above, but can be altered by a skilled person in the art within the scope of the claims. The present disclosure also encompasses, in its technical scope, any embodiment derived by combining technical means disclosed in differing embodiments as appropriate.

### REFERENCE SIGNS LIST

10: information processing device
20: server
30: vehicle
100: control section
102: first determining section
103: second determining section
104: third determining section
CP1, CP2, CP3: suspension time period (first suspension time period, second suspension time period)
CT: content
CT1: non-advertisement content
CT2: advertisement content
T1, T2, T3, T4, T5, T6: timing

1. An information processing device that provides content including advertisement content and non-advertisement content to a passenger of a traveling body, the information processing device comprising:
a first determining section configured to determine whether the traveling body is traveling or the traveling body has stopped traveling; and
a second determining section configured to determine, on a basis of whether a first time period elapsed from a timing of starting provision of the non-advertisement content is a given first suspension time period, whether to permit suspension of provision of the non-advertisement content,
provision of the non-advertisement content being suspended and provision of the advertisement content being started, in a case where (a) the first determining section determines that the traveling body has stopped traveling while the non-advertisement content is being provided and (b) the second determining section determines to permit suspension of provision of the non-advertisement content.

2. The information processing device according to claim 1, further comprising:
a third determining section configured to determine, on a basis of whether or not a second time period elapsed from a timing of starting provision of the advertisement content is a given second suspension time period, whether to permit suspension of provision of the advertisement content, wherein:
provision of the advertisement content is suspended, in a case where (a) the first determining section determines that the traveling body is traveling while provision of the non-advertisement content is suspended and the advertisement content is being provided and (b) the third determining section determines to permit suspension of provision of the advertisement content.

3. The information processing device according to claim 2, wherein:
provision of the non-advertisement content whose provision has been suspended is restarted, in a case where (a) the first determining section determines that the traveling body is traveling while provision of the non-advertisement content is suspended and the advertisement content is being provided and (b) the third determining section determines to permit suspension of provision of the advertisement content.

4. A content switching method that switches content which is to be provided to a passenger of a traveling body between advertisement content and non-advertisement content, the content switching method comprising:
suspending provision of the non-advertisement content and starting provision of the advertisement content, in a case where (a) the traveling body stops while the non-advertisement content is being provided and (b) a time period elapsed from a timing of starting provision of the non-advertisement content is a given time period.

5. A vehicle comprising an information processing device recited in claim 1.

6. A program for causing a computer to function as an information processing device recited in claim 1, the program causing the computer to function as the first determining section and the second determining section.
